(19) United States
(12) Patent Application Publication
(10) Pub. No.: US 2017/0370056 A1
(43) Pub. Date: Dec. 28, 2017

(54) ANIMAL WASTE BAG

(71) Applicant: SUSAN McDONALD, WASHINGTON, DC (US)

(72) Inventor: SUSAN McDONALD, WASHINGTON, DC (US)

(21) Appl. No.: 15/634,275

(22) Filed: Jun. 27, 2017

Related U.S. Application Data
(60) Provisional application No. 62/355,521, filed on Jun. 28, 2016.

(51) Int. Cl. E01H 1/12; A01K 23/00; B65D 33/28; B65H 35/10; B65D 33/16

(52) U.S. Cl. CPC E01H 1/1206; B65H 35/10; B65D 33/1608; B65D 33/28; A01K 23/005; B65H 2402/41; B65H 2701/191; E01H 2001/128

(57) ABSTRACT

A waste bag for animal excrement. The waste bag may include independent drawstrings for cinching the bag.

### RELATED APPLICATIONS

The present application claims priority to U.S. Provisional Application, Ser. No. 62/355,521, filed on Jun. 28, 2016.

### BACKGROUND OF THE INVENTION

The present invention relates to closeable waste bags, and, more particularly to closeable waste bags for animal waste. Most commonly used animal waste bags are bags for use with dogs.

Dog waste bags, commonly referred to as “poop bags,” are available to consumers under many different brand names and sold widely in venues ranging from large pet retailers to small boutique pet stores. The many brands of poop bags, while varying in design and composition, are generally similar in size and packaging. The most commonly used poop bags may be broken down into two models: those with handles, aka “t-shirt” bags, and those without handles (handleless bags).

A further problem with the existing handle and handleless poop bags is getting them open. The plastic material used for these bags undergoes pressure during the manufacturing process to maximize the number of bags on each roll. This pressure, combined with static electricity common to thin plastics, causes the various parts of the bag to stick together. Further, as indicated previously, each bag on a roll is separated from the next bag by small, tightly spaced perforations. When users attempt to tear one bag from the next, the tight perforations do not loosen completely and the top of the bag remains partially sealed. To open the bags whether they are t-shirt or handleless many users find it necessary to moisten their thumb and forefinger and rub the top of each bag until separation is achieved.

If a poop bag does not seal securely, users risk spillage and the emanation of a foul odor. The t-shirt and handleless models are both hard to seal securely, particularly while holding one or more dog leashes or wearing gloves. T-shirt bag handles are short and hard to manipulate. Users must tie and/or knot the handles very tightly, or else gaps will form around the handles. To seal handleless bags, users must knot the neck of the bag. This requires a certain dexterity and distracts users' attention away from their pet and its leash. A poorly tied knot may unravel during transport. Frustrated users may even abandon attempts to tie a knot and discard the used bag without securing it.

Users should be able to carry used poop bags in a way that leaves both of their hands free to attend to the needs of their pet. T-shirt bags are easier to carry than handleless bags. Yet all t-shirt models have short handles. After a user ties the handles together to seal the bag, the handles become too short to be draped around a user's wrist-thus thwarting the ease and convenience of “hands-free” transport. As for handleless bags, users generally carry them by the knot in the neck of the bag, which again does not provide for hands-free transport. Further, the bag, having no handles, can easily slip from the user's hand.

Other waste bags, e.g. standard kitchen trash can garbage bags, also have disadvantages. Consider the common loop-ended drawstring bags. These bags seem to indicate that pulling each looped drawstring handle will fully close the bag. This is not the case. Specifically, this type of bag is designed with a “tunnel” at the top of the bag through which the drawstring moves. When users attempt to fully close the bag, it becomes apparent that the drawstring tunnel is stitched on both (opposing) sides of the tunnel. So the drawstring does not flow smoothly through the entire tunnel-rather, each side of the bag cinches independently. The result is similar to the t-shirt poop bag: even after a user firmly pulls the looped handles, a gap appears on either side of the top of the bag until users tie the handles tightly together (which sometimes is not achievable).

### SUMMARY OF THE INVENTION

The present invention is directed towards an animal waste bag, e.g. a dog waste bag, that will securely contain the waste in the bag. The invention is further directed towards a waste bag that will be able to cinch tightly to secure the waste within the bag.

The present invention preferably comprises a bag made from a type of plastic that is commonly used for waste bags. The bag will further comprise two drawstrings made from a similar plastic, each drawstring encircling without obstruction the entire circumference of the bag within a “tunnel” around the top of the bag, with each drawstring having looped ends that protrude from two openings on opposing sides of the tunnel.

The present invention may also have a semicircular tab located on the bag. The present invention may further have an opening or hole located on the semicircular tab, e.g. a pull ring.

The present invention further includes kits and systems that include waste bags according to the present invention.

### BRIEF DESCRIPTION OF THE DRAWINGS

FIG. 1 is a perspective view of a roll holding a plurality of bags according to the present invention.

FIG. 2 is a front planar view of the roll shown in FIG. 1.

FIG. 3 is a perspective view of a commonly used dispenser for the bags shown in FIG. 1.

FIG. 4 is an overhead view of a bag according to the present invention after being removed from a dispenser.

FIG. 5 is a side planar view of the bag shown in FIG. 4.

FIG. 6 shows the bag of FIG. 4 being unfolded.

FIG. 7A is a cross-sectional view of the bag of FIG. 6 taken along the line 7A-7A.

FIG. 7B is a cross-sectional view of the bag of FIG. 6 taken along the line 7B-7B.

FIG. 8 demonstrates the bag of FIG. 6 in a closed position.

FIG. 9 depicts an arrangement of the bag of FIG. 6, wherein the location of the drawstrings is a different location.

FIG. 10 depicts the bag of FIG. 9 in a closed position.

FIG. 11 depicts the bag of FIG. 9 with an additional pull ring locates on the bag.

FIG. 12 depicts the bag of FIG. 11 in a closed position.

FIG. 13 depicts of a bag of the present invention, being folded for storage prior to use.

FIG. 14 depicts the bag shown in FIG. 14 in an unfolded position.

FIG. 15A is a cross-sectional view of the bag of FIG. 14 taken along the line 15A-15A.

FIG. 15B is a cross-sectional view of the bag of FIG. 4 taken along the line 15B-15B.

FIG. 16 depicts the bag of FIG. 13 in a closed position.

FIG. 17 is a further arrangement of a perspective view of a roll holding a plurality of bags according to the present invention.

FIG. 18 is a front planar view of the roll shown in FIG. 17.

FIG. 19 is a plurality of bags shown in FIG. 17 in an unrolled arrangement.

FIG. 20 is a perspective view of a commonly used dispenser for the bags shown in FIG. 19.

FIG. 21 is an overhead view of a bag according to the present invention after being removed from a dispenser.

FIG. 21A is a cross-sectional view of the bag of FIG. 21 taken along the line 21A-21A.

FIG. 22 is the bag of 21 in a closed position.

FIG. 23 is the bag according to the present invention further including cutout areas to assist the user in grabbing the animal waste.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

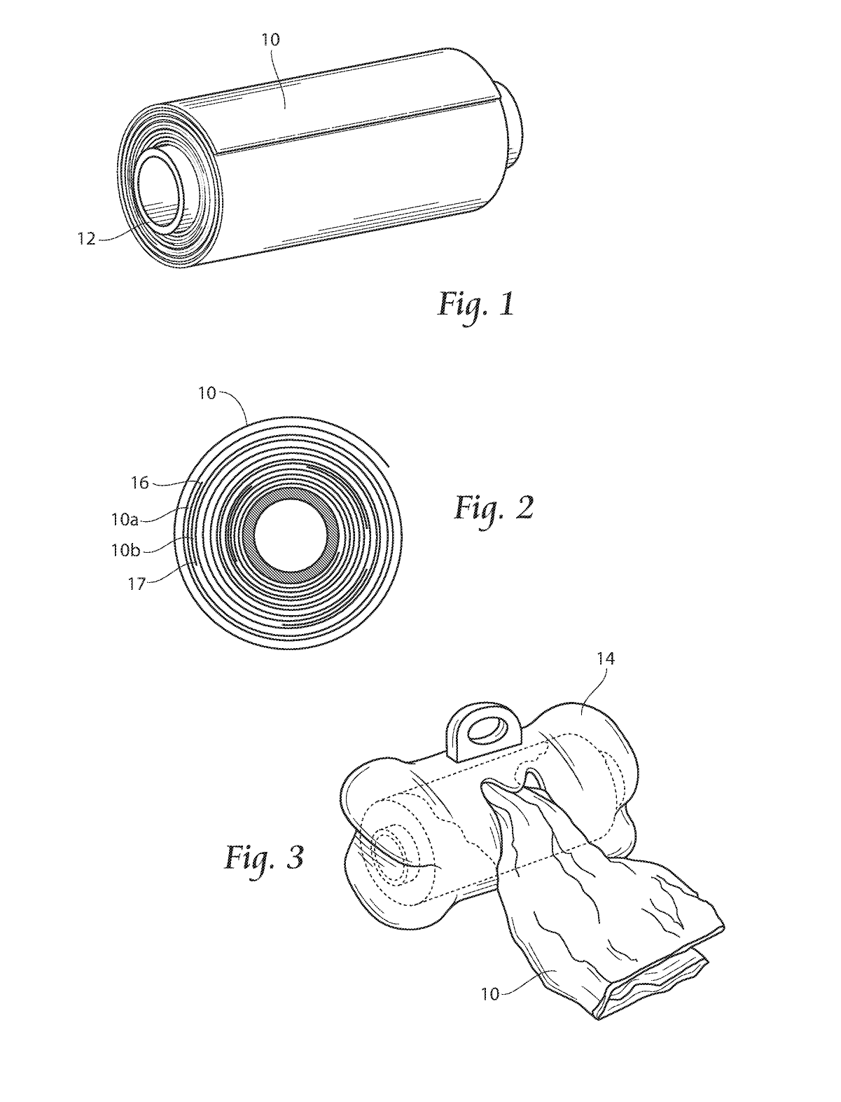

FIGS. 1 and 2 depict a plurality of waste bags 10 according to the present invention. The bags are located on a roll 12, as they would be when within a dispenser 14, as shown in FIG. 3. As can be seen in FIG. 2, the bags 10 are separately stored on the roll 12, with the first end 16 of a bag 10a overlapping the second end 17 of a bag 10b. Such an arrangement is opposite of typical waste bags, wherein the first end 16 and the second end 16 would be directly attached. The arrangement allows for the bags 10 to be easily removed from a dispenser 14 (FIG. 3).

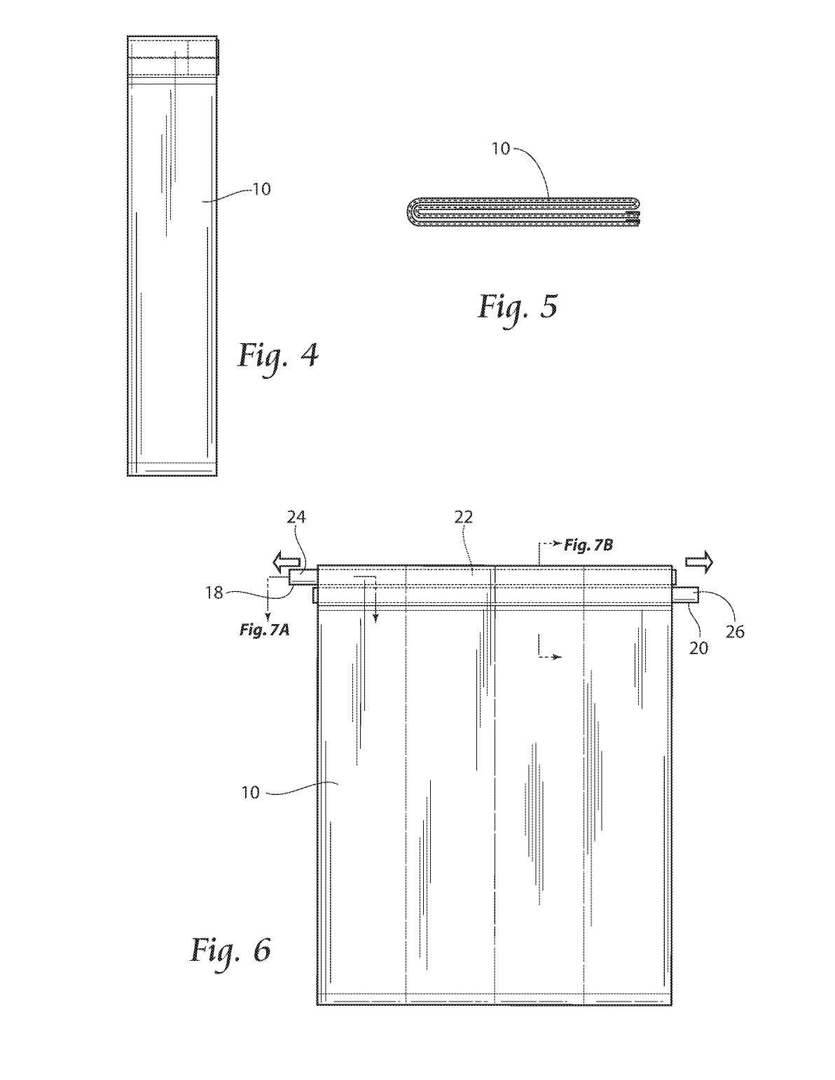

As shown in FIG. 3, the bags 10 are preferably in a folded relationship when within the dispenser 14. This is further demonstrated in FIGS. 4 and 5, with the bag 10 folded along a central axis, preferably symmetrical. Because the bags are preferably not attached by perforations, the folded arrangement not only allows for a more compact and efficient storage minimizes snags and other issues associated with the prior art perforated bags, as the bags are stored and removed from the dispenser at generally the same width.

Once the bag 10 is removed from the dispenser 14, the bag 10 will be unfolded, as shown in FIG. 6. The unfolded bag 10 reveals a pair of individual drawstrings 18 and 20, which are located within a tunnel 22 that goes around the entire circumference of the bag 10. Each of the drawstrings 18, 20 extend outwardly of the bag 10 at a respective end and form tabs 24, 26, respectively, which will allow for the bag 10 to be cinched independently from two opposing directions.

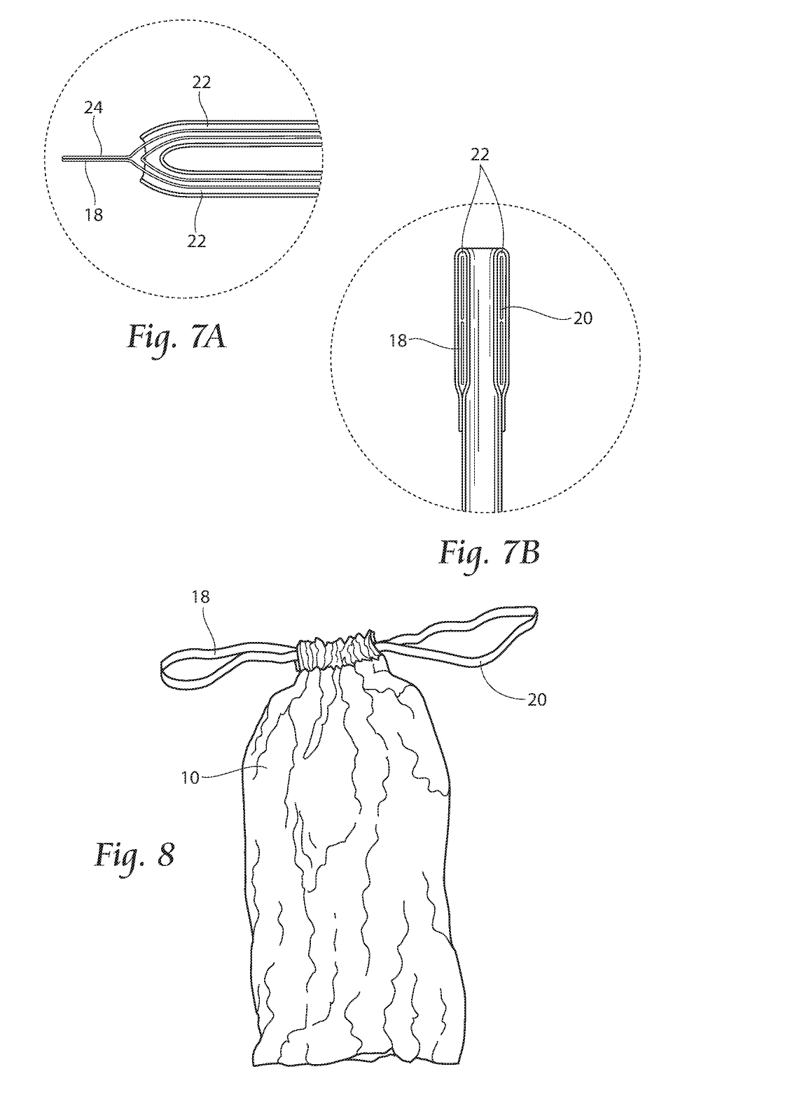

For example, FIG. 7A depicts a cross-sectional view of the bag 10, demonstrating that the drawstring 18 is attached to itself, thereby forming an independent continuous loop through the tunnel 22, as noted with respect to FIG. 6. Drawstring 18 will be attached in a similar fashion, also forming an independent continuous loop through the tunnel 22, as well, but having tab 26 located at an opposing position to that of tab 24.

FIG. 7B provides a cross-sectional view of the bag looking through the tunnel 22, further demonstrating that the drawstrings 18 and 20 are independently positioned within the tunnel 22.

Once the bag 10 is removed and unfolded from the dispenser 14, the bag 10 can be used to hold animal waste. Once the waste is within the bag 10, the drawstrings 18 and 20 can be pulled in opposite directions (depicted by arrows in FIG. 6), thereby providing a securely fastened bag 10, as shown in FIG. 8.

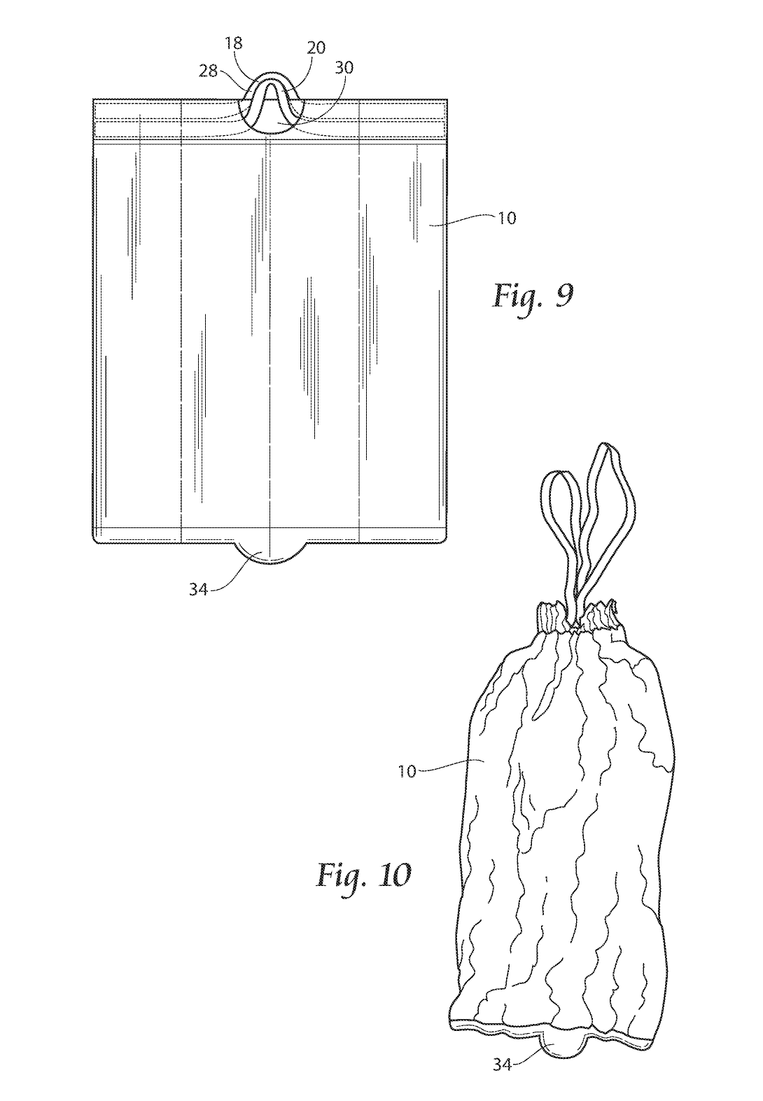

It is understood that the present invention is directed towards waste bags that have two independently accessible and separate drawstrings located within the bag 10. Provide such an arrangement is contemplated, it is understood that the arrangement would fall within the scope of the present invention. For example, FIGS. 9 and 10 demonstrate an arrangement wherein the tabs 20, 22 of the drawstrings 16, 18 are centrally located on cut-outs 26, 28 on the bag 10, with the tabs 16, 18 being the area of the drawstrings 16, 18 extending outwardly of the cut-outs 28, 30.

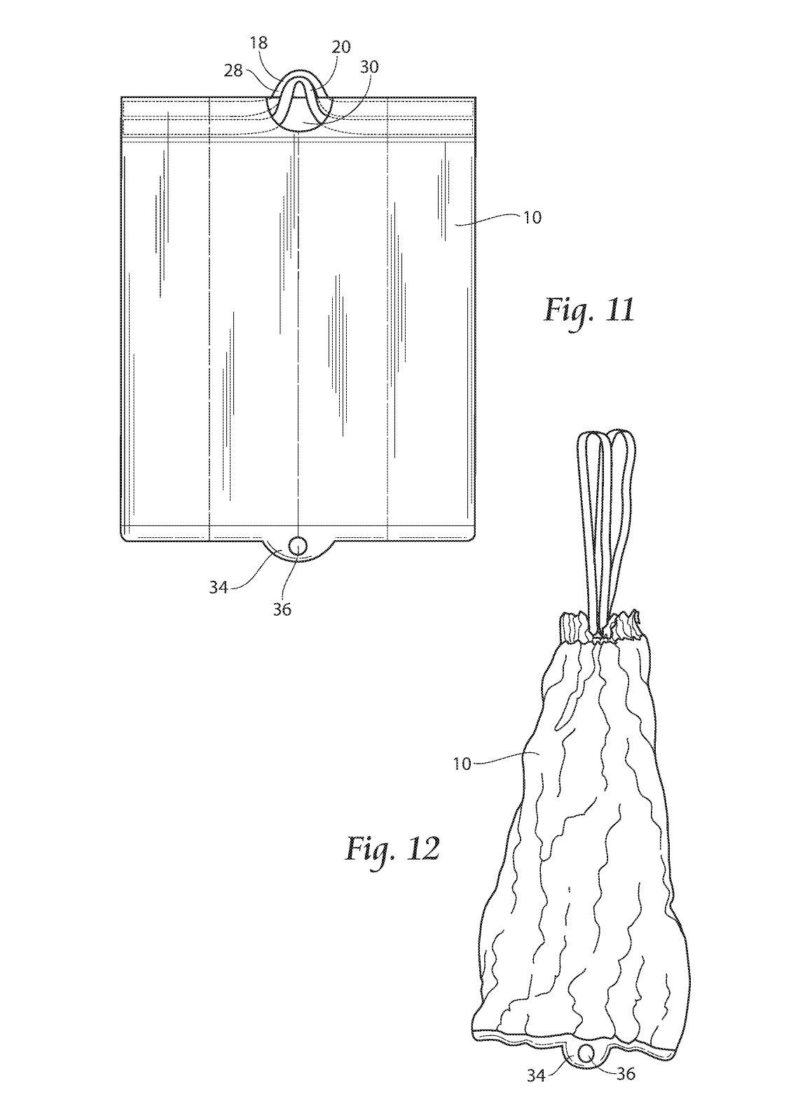

Such an arrangement may also work together with a pull-tab 30, which allows the user to provide upward and downward opposing forces, thereby securing the waste within the bag 10, as shown in FIGS. 10 and 12. As shown in FIGS. 11 and 12, the pull-tab 32 may further comprise a pull ring 34, which can assist the user in securing the bag.

Accordingly, the present invention has numerous advantages over the prior art. The advantages include one or more of the following aspects: to provide a double-drawstring bag that cinches closed with one pulling motion, that closes tightly with no gaps, that does not require tying or knotting for secure closure but which offers the option to do so, that has loops to serve as handles which facilitate bag closure and transport, that can be folded and packaged into a roll that fits into standard dog waste bags dispensers, that pulls smoothly out of a dispenser and separates easily from its predecessor bag, that is easy to open at the top with thumb and forefinger, and that can be manufactured using readily available materials and processes.

Further, from the description above, a number of advantages of the double-drawstring dog waste bag become evident:

(a) Easy to grip the end of the bag to pull it from a dispenser using the pull tab [or pull ring] at the bottom of the bag.

(b) Easy to remove bag from the dispenser because the bags on the roll are not attached to one another but instead overlaid on one another, so there are no perforations to tear.

(c) Easy to open because the extra thickness provided at the top of the bag by the drawstring tunnel makes it easy to separate the top by thumb and forefinger.

(d) When the bag is opened, the drawstring loop handles are immediately visible and easy to grasp.

(e) Seals easily and securely with one pulling motion.

(f) Seals tightly with no gaps at the top of the bag.

(g) Once the bag is closed, the loop handles are long enough to be draped around the wrist for hands-free transport.

(h) Can be manufactured economically using readily available materials and processes.

As discussed above, the purpose of the present invention is to provide an animal waste bag to efficiently secure waste within the bag. The following description provides further arrangements of waste bags 10 according to the present invention to achieve this goal.

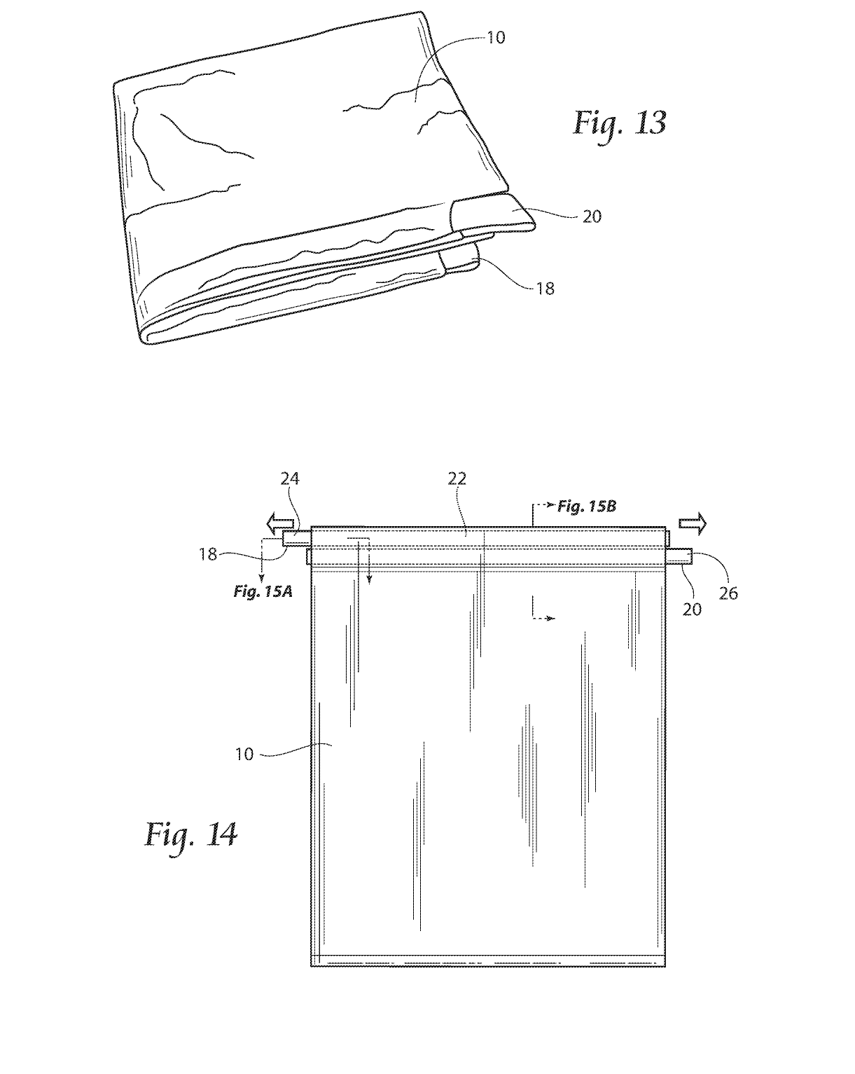

FIG. 13 provides the waste bag 10 in an alternate arrangement for storing the bags prior to using the bags. As opposed to the roll of bags 10 shown in FIGS. 1 and 2, the bags are arranged and folded individually, which allows for an easier way to separate the bags than in the prior art. The bags 10 can be stored and dispensed from the dispenser 14, as previously noted in FIG. 3.

In FIG. 14, the unfolded bag 10 reveals a pair of individual drawstrings 18 and 20, which are located within a tunnel 22 that goes around the entire circumference of the bag 10. Each of the drawstrings 18, 20 extend outwardly of the bag 10 at a respective end and form a tab 24, 26, respectively, which will allow for the bag 10 to be cinched independently from two opposing directions.

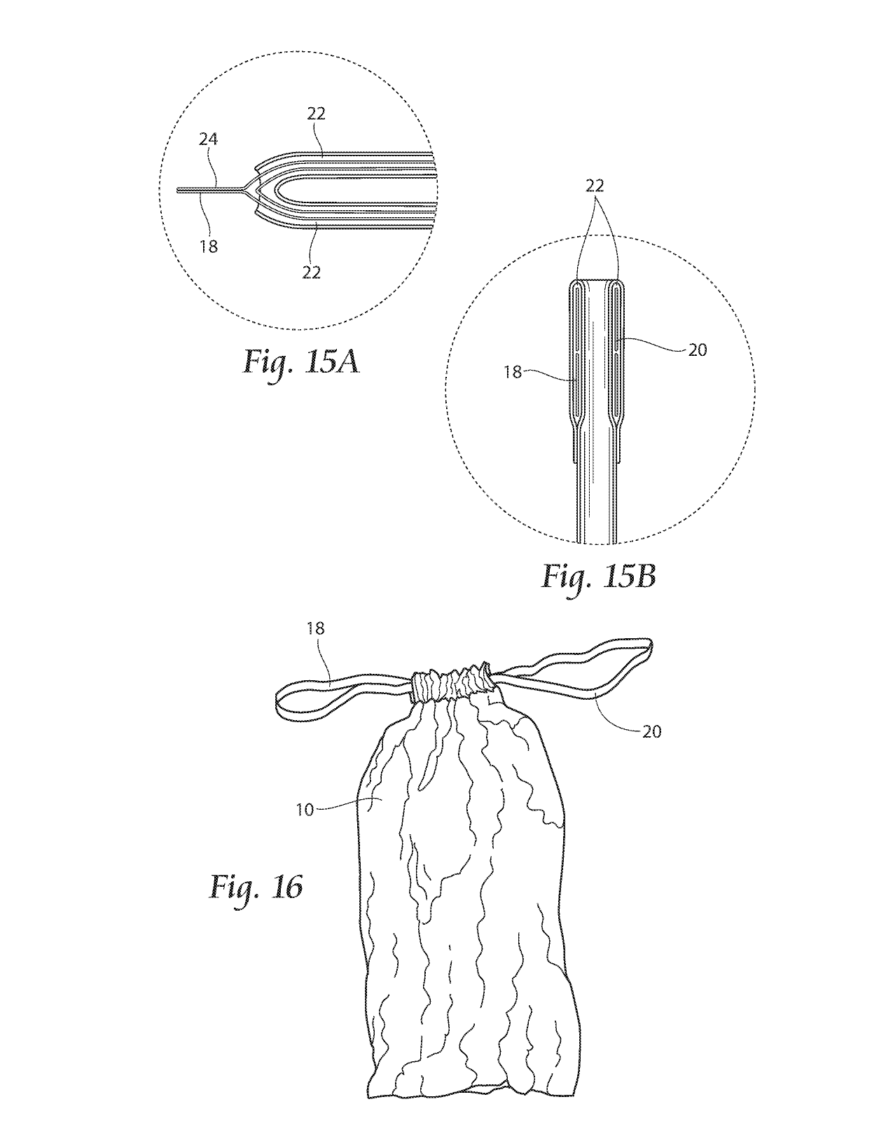

As previously discussed in FIG. 7A, FIG. 15A depicts a cross-sectional view of the bag 10, demonstrating that the drawstring 18 is attached to itself, thereby forming an independent continuous loop through the tunnel 22, as noted with respect to FIG. 14. Drawstring 18 will be attached in a similar fashion, also forming an independent continuous loop through the tunnel 22, as well, but having tab 26 located at an opposing position to that of tab 24.

FIGS. 15A and 15B provide cross-sectional views of the bag looking through the tunnel 22, further demonstrating that the drawstrings 18 and 20 are independently positioned within the tunnel 22.

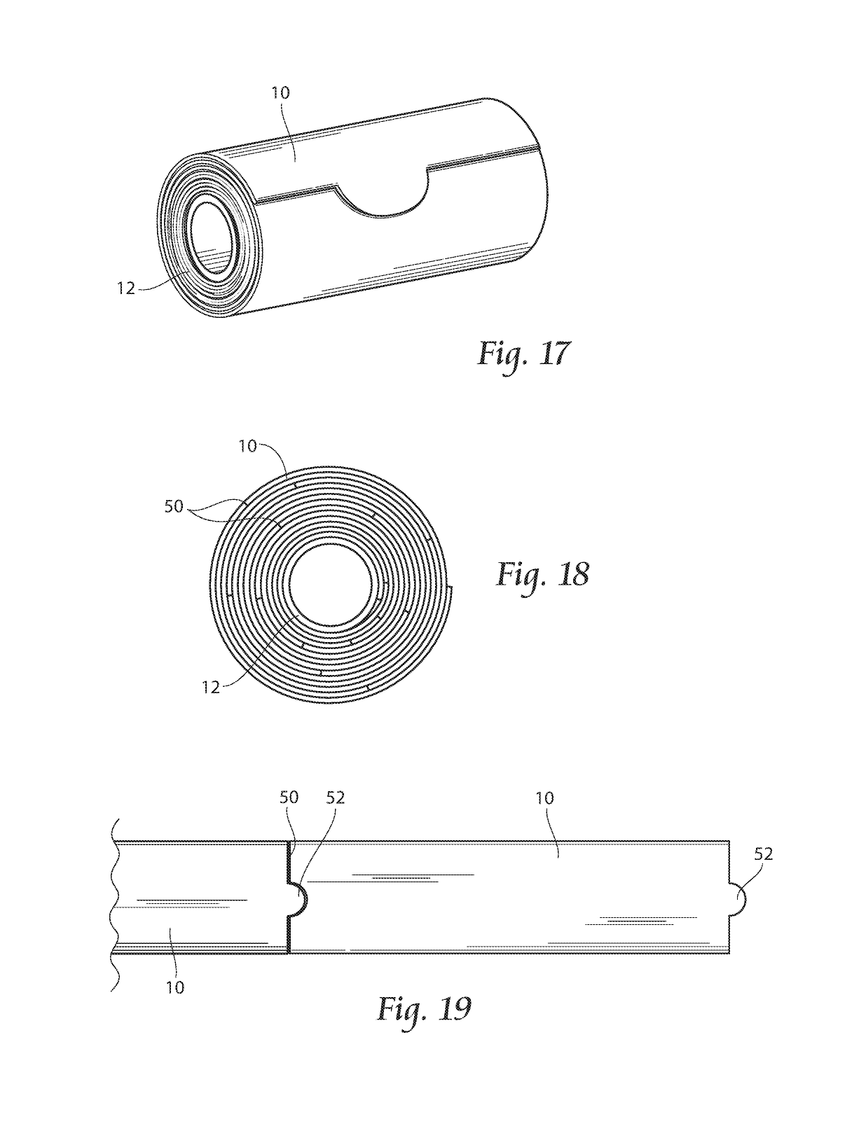

Once the bag 10 is removed and unfolded from the dispenser 14, the bag 10 can be used to hold animal waste. Once the waste is within the bag 10, the drawstrings 18 and 20 can be pulled in opposite directions (depicted by arrows in FIG. 14), thereby providing a securely fastened bag 10, as shown in FIG. 16.

FIGS. 17 and 18 show the bags being stored prior to dispensing. As shown previously in FIGS. 1 and 2, the bags 10 are located on the roll 12, as they would be in the dispenser (see FIG. 13). However, as noted in FIGS. 17 and 18 the bags are not arranged in a separate overlapping manner, but are designed to be stored as a singular sheet of bags 10, separated by perforations 50. A flap 52 is also shown on the bags 10. The flap 52 is a distinct extension from the bag, preferably a semicircle shape.

In FIG. 19, the perforations 50 are shown between the bags, with the perforations 50 being aligned with the sides of connected respective bags 10. The perforations also follow the contour of the flap 52 and are preferably non-linear, e.g. including a semicircle shape. The bags may also have a colored strip or area located along the side of the bag to help delineate one bag from another, particularly when removing the bags 10 from the roll 12.

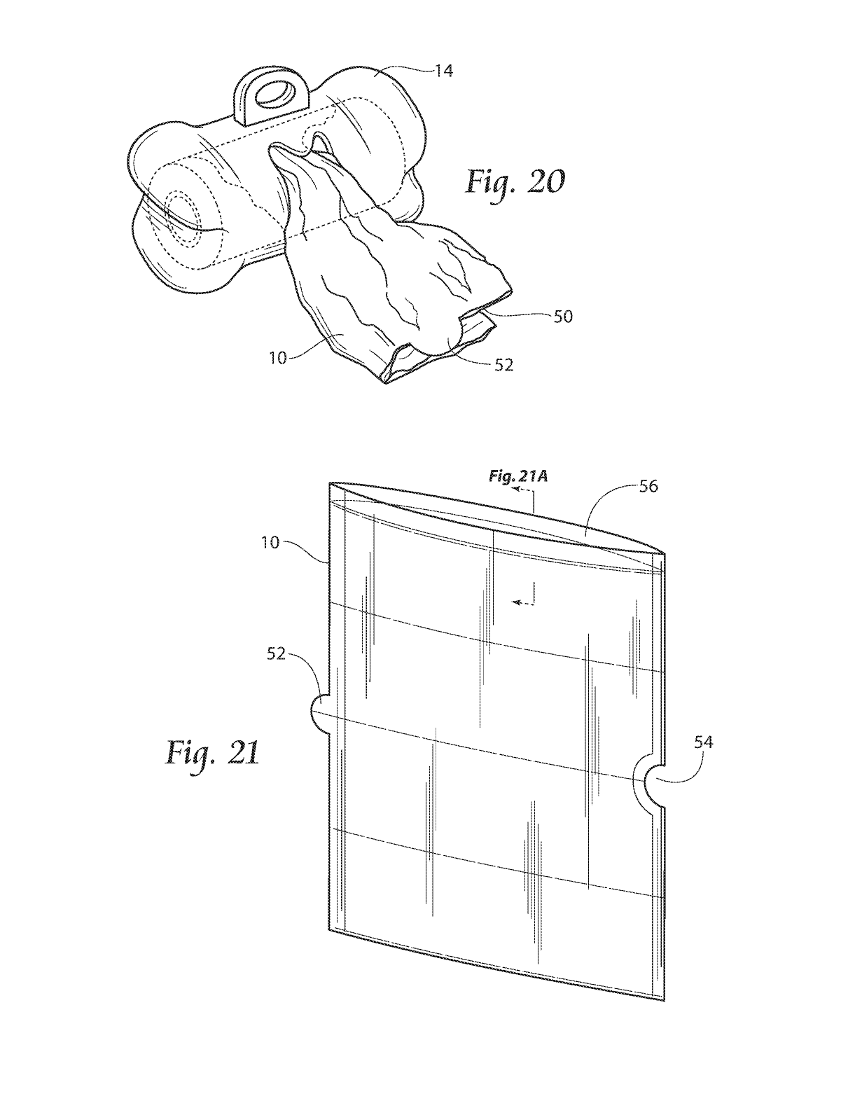

As demonstrated in FIG. 20, the bags 10 will be dispensed, as previously discussed. As one bag 10 is pulled from the dispenser 14 by the flap 52, the bag 10 is pulled from the perforation 50 connected to the next bag 10, leaving the flap 52 for the next bag.

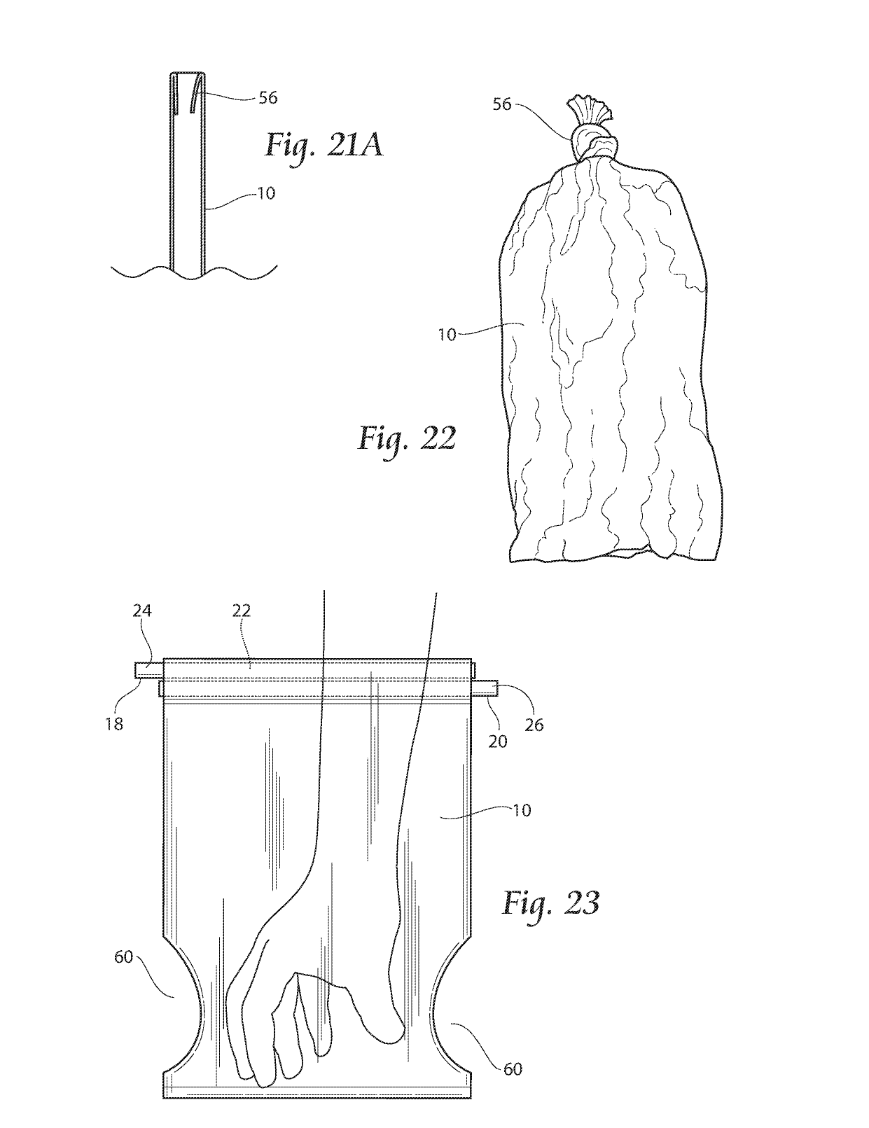

The unfolded bag 10 is shown in FIG. 21. As describe above, the bag 10 has the flap 52 on one side of the bag, with a corresponding indent 54 located on the other side of the bag 10. The bag 10 also includes a fold-over flap 56 at the top of the bag, similar to the tunnel 22 previously discussed, without the drawstrings. The fold-over flap 56 make it extremely easy to separate the top of the bag with the user's thumb and forefinger. As shown in FIGS. 21 and 21A, the flap 56 extends inwardly into the cavity of the bag 10. While the flap 56 is preferably loose from the bag 10 when folded over, it is possible that the flap 56 could also be secured, e.g. bonded to the bag itself. The user will seal the bag by tying a knot in the top.

The purpose of the present invention is to provide an animal waste bag 10 that is more-user friendly than prior bags. For example, it is also contemplated that the above described bag 10 could also be designed such that it will be easier for the user when grabbing the animal waste. FIG. 23 demonstrates such a design. The bag 10 is as described above, but has cutouts 60 located at the bottom of the bag 10 that generally correspond to a user's hand when inserted into the bag 10. The cutouts 60 are located near the bottom of the bag 10 and follow the sides of the bags 10. That is, the cutouts 60, i.e. are not opens but contoured areas along the sides of the bag 10. As shown, the contours 60 are semicircular indents, which aid in the bag moving inwardly around the animal waste when grabbed by the user.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

1. A system for collecting animal excrement comprising:
a bag comprising:
a solid body forming a container, said body having a right side, a left side, a bottom and a top;
wherein the top is open for insertion of said animal excrement,
said top having an extended area of material thereby allowing the bag to be tied shut after collection.

2. The system according to claim 1, wherein said right side has a flap shaped contour extending outwardly from the right side, said left side having a mating inwardly flap shaped contour.

3. The system according to claim 2, wherein the system comprises a plurality of bags.

4. The systems according to claim 3, wherein the plurality of bags are connected by perforations located on the right and left side of the bags.

5. The system according to claim 4, wherein the system comprises a dispenser for said bags, said dispenser allowing bags to be removed individually along said perforations.

6. A bag for collecting animal excrement comprising:
a main body having an opening on a top side of the body;
a tunnel located on the top side of the body, the tunnel forming a circumference around the body;
a pair of individual drawstrings located within the, wherein the drawstrings are independently pulled to cinch the bag after collecting the animal excrement.

7. The bag according to claim 6, wherein the pair of drawstrings are capable of being pulled in opposing directions.

8. The bag according to claim 7, wherein each of said drawstrings forms a respective tab to assist in cinching the bag.

9. The bag according to claim 8, further comprising a pair of oppositely disposed inwardly facing contours located on the sides of the bag.

10. A system for collecting animal excrement comprising:
a dispenser; and
a bag according to claim 8 located within said dispenser.

11. The system according to claim 10, comprising a plurality of said bags.

12. The system of claim 11, wherein the bags are individually stored within said dispenser.
